(19) United States
(12) Patent Application Publication
(10) Pub. No.: US 2022/0307109 A1
(43) Pub. Date: Sep. 29, 2022

(54) Tungsten Tetraboride Tooling

(71) Applicant: Millennitek, LLC, Knoxville, TN (US)

(72) Inventors: Andrew M. Spradling, Knoxville, TN (US); Lawrence W. Townsend, Knoxville, TN (US); Kevin J. Hughes, Knoxville, TN (US)

(73) Assignee: Millennitek, LLC, Knoxville, TN (US)

(21) Appl. No.: 17/805,551

(22) Filed: Jun. 6, 2022

Related U.S. Application Data
(63) Continuation-in-part of application No. 16/947,015, filed on Jul. 15, 2020, now Pat. No. 11,351,609.

(51) Int. Cl. C22C 1/05; C01B 35/04; C22C 29/14

(52) U.S. Cl. CPC C22C 1/051; C01B 35/04; C22C 29/14

(57) ABSTRACT

A method of forming cemented tungsten tetraboride, by combining tungsten and boron in a molar ratio of from about 1:6 to about 1:12, respectively, and firing the combined tungsten and boron in a hexagonal boron nitride crucible at a temperature of from about 1600 C to about 2000 C, to form tungsten tetraboride, milling the tungsten tetraboride to a powder, adding a metal binder to the tungsten tetraboride powder to produce a metal-tungsten tetraboride mixture, compressing the metal-tungsten tetraboride mixture, and sintering the compressed metal-tungsten tetraboride mixture to form cemented tungsten tetraboride.

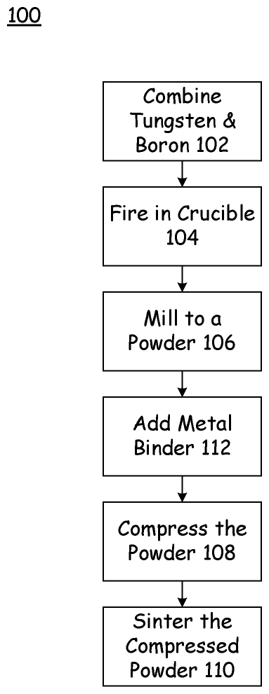

This application claims rights and priority on prior pending U.S. patent application Ser. No. 16947015 filed Jul. 15, 2020, the entirety of the disclosure of which is incorporated herein by reference as though laid out in full.

### FIELD

Various embodiments of the invention described in this disclosure arose in the performance of contract 80NSSC19C0573 with the NASA Shared Services Center and contract DE-SC0020727 with the Department of Energy. The United States government has certain rights in the invention.

This invention relates to the field of tooling. More particularly, this invention relates to forming tungsten tetraboride tooling.

### INTRODUCTION

In 2018, the Department of the Interior identified thirty-five minerals considered critical to the economic and national security of the United States, with the intent of reducing the reliance on other countries for the supply of these critical materials. Cobalt and tungsten were included on that list.

Cobalt is used, inter alia, to cement tungsten carbide to tooling. Roughly 60% of the tungsten used in the US and 9% of the cobalt is used to make cobalt-cemented tungsten carbide tooling. Reducing the needed amounts of these materials could have a significant impact on US dependence on foreign sources of these elements.

However, any alternative to cobalt-cemented tungsten carbide would only be desirable if the same or better performance could be demonstrated. The key properties of cobalt-cemented tungsten carbide are hardness, wear resistance, thermal stability, corrosion resistance, and tranverse rupture strength. The performance of cobalt-cemented tungsten carbide results from the combination of the hardness and durability of tungsten carbide with the strength and malleability of the cobalt bond.

What is needed, therefore, is a tooling that tends to reduce issues such as those described above, at least in part.

### SUMMARY

The above and other needs are met by a method of forming cemented tungsten tetraboride, by combining tungsten and boron in a molar ratio of from about 1:6 to about 1:12, respectively, and firing the combined tungsten and boron in a hexagonal boron nitride crucible at a temperature of from about 1600 C to about 2000 C, to form tungsten tetraboride powder, milling the tungsten tetraboride to a powder as needed or desired, adding a metal binder to the tungsten tetraboride powder to produce a metal-tungsten tetraboride mixture, compressing the metal-tungsten tetraboride mixture, and sintering the compressed metal-tungsten tetraboride mixture to form cemented tungsten tetraboride.

In some embodiments, the metal binder is at least one of copper, iron, and nickel. In some embodiments, the temperature is about 1800 C. In some embodiments, the firing is accomplished at about one atmosphere. In some embodiments, the firing is accomplished in an argon environment. In some embodiments, the tungsten is provided as tungsten oxide. In some embodiments, the boron is provided as boric acid. In some embodiments, the tungsten is provided as tungsten metal. In some embodiments, the boron is provided as boron metal. In some embodiments, the tungsten and the boron are combined with carbon in the crucible. In some embodiments, the sintering comprises at least one of spark plasma sintering, hot pressing, and vacuum sintering. In some embodiments, the firing is accomplished in one of an argon environment or a vacuum environment, and the sintering is accomplished using spark plasma sintering or hot pressing in one of an argon environment or a vacuum environment.

### DRAWINGS

Further advantages of the invention are apparent by reference to the detailed description when considered in conjunction with the FIGURES, which are not to scale so as to more clearly show the details, wherein like reference numbers indicate like elements throughout the several views, and which depicts a flow chart for a method for making cemented tungsten tetraboride tooling according to an embodiment of the present invention.

### DESCRIPTION

Production of Tungsten Tetraboride

With reference now to the FIGURE, there is described a general procedure 100 for preparing cemented tungsten tetraboride (WB₄) according to the embodiments herein. The raw tungsten and boron powders are combined as given in block 102. The mixture is placed into a high purity boron nitride crucible and processed in a continuous furnace under argon atmosphere at ambient pressure and at temperatures of from about 1800 C to about 2000 C, as given in block 104. The resulting synthesized material is then milled in acetone to a particle size of from about one micron to about three microns and then again allowed to dry, as given in block 106. Alternately, the synthesized powder is not milled and used directly. Block 112 is not a part of the process when only WB₄ is to be produced. The WB₄ powder is compressed, as given in block 108, and then sintered, as given in block 110.

Production of Tooling

Various embodiments of the present disclosure make a hard tooling material based on tungsten tetraboride, which is superior to cobalt-cemented tungsten carbide. The various methods include synthesis of pure tungsten tetraboride as described above, with the addition of a binder material, as given in block 112.

Consolidation

In various embodiments, pure tungsten tetraboride powder is mixed with a metal binder prior to compression and sintering. The compression and sintering is generally referred to herein as consolidation.

Between about six to twenty weight percent of a cementing metal is combined with the tungsten tetraboride powder. Cementing metals in various embodiments include copper with particle sizes of between about one micron and about five microns, iron with particle sizes of between about one micron and about nine microns, and nickel with particle sizes of between about four microns and about eight microns. In various embodiments, the metal binder is added to the tungsten tetraboride powder and then milled for an additional sixteen hours or so, or added to the fired tungsten tetraboride powder before a final seventy-two hour milling stage. In various embodiments, the metal binder is added to the tungsten tetraboride powder and blended and dispersed using ultrasonic energy without any mechanical milling. These materials are variously referred to as Cu—WB₄, Fe—WB₄, and Ni—WB₄.

Compaction

In some embodiments, the tungsten tetraboride—cement-metal mixtures are compacted using one or more of three different techniques, including hot pressing, spark plasma sintering (SPS, also called direct current sintering or DCS), and dry pressing followed by vacuum sintering (pressureless sintering).

There are two potential advantages of SPS. The first is that it is faster than the other techniques, taking minutes instead of hours. The second advantage is that due to the speed of processing, grain growth is limited and so it tends to produce a stronger compact.

Table 1 below summarizes the processing for some samples that were prepared according to the various embodiments described herein.

TABLE 1

| Powder | | Compacting | Pressure |
|---|---|---|---|
| composition | Compacting method | temperature (C.) | (MPa) |
| Cu-WB4 | Hot pressing | 1045 | |
| Ni-WB4 | Hot pressing | 1400 | |
| Ni-WB4 | Hot pressing | 1450 | |
| Co-WB4 | Hot pressing | 1450 | |
| Fe-WB4 | Hot pressing | 1480 | |
| Pure WB4 | Hot pressing | 1840 | |
| Pure WB4 | Hot pressing | 2000 | |
| Cu-WB4 | Spark plasma sintering | 990 | 80 |
| Cu-WB4 | Spark plasma sintering | 980 | 80 |
| Ni-WB4 | Spark plasma sintering | 1340 | |
| Fe-WB4 | Spark plasma sintering | 1420 | |
| Ni-WB4 | Spark plasma sintering | 1460 | |
| Ni-WB4 | Spark plasma sintering | 1540 | |
| Ni-WB4 | Spark plasma sintering | 1620 | |
| Pure WB4 | Spark plasma sintering | 1940 | 80 |
| Cu-WB4 | Pressureless sintering | 1045 | NA |
| Ni-WB4 | Pressureless sintering | 1400 | NA |
| Fe-WB4 | Pressureless sintering | 1480 | NA |
| Ni-WB4 | Pressureless sintering | 1450 | NA |
| Ni-WB4 | Pressureless sintering | 1475 | NA |

The materials shown in Table 1 were made by mixing tungsten tetraboride with about 6% copper, iron, or nickel, then consolidating with hot pressing, SPS, or vacuum sintering.

The consolidated materials were analyzed for bulk density, microstructure, and hardness. The densities of all the materials are significantly lower than cobalt-cemented tungsten carbide (˜14.5 g/cm³). SPS and hot pressing give a higher density at the same temperature as pressureless vacuum sintering. Within these two methods, density generally increases with temperature.

Another significant result is the dramatic increase in density in the SPS Ni—WB₄ material with increasing temperature. When increasing the consolidation temperature from 1540° C. to 1620° C., density increases from roughly 4.5 to 5.5 g/cm³. The effect of consolidation temperature on microstructure and hardness of the SPS Ni—WB₄ samples is discussed in more detail below.

The materials were analyzed for microstructure and composition using SEM-EDS. The first trend is that a high degree of inhomogeneity was observed in the materials. All tungsten tetraboride-based materials tend to exhibit inhomogeneity, even pure tungsten tetraboride.

TABLE 2

| | | | Bulk density |
|---|---|---|---|
| Test type | Nominal dimensions | Samples | (g/cm³) |
| Flexural | Rectangular bar | Hot Pressed Ni-WB4 (1450 C.) | 4.06 ± 0.09 |
| strength | 3 mm × 4 mm × 40/50 mm | DCS Ni-WB4 (1900 C.) | 5.68 ± 0.14 |
| Compressive | Cylinder | Hot Pressed Ni-WB4 (1450 C.) | 3.97 ± 0.03 |
| strength | 5 mm OD × 12.5 mm L | DCS Ni-WB4 (1800 C.) | 5.73 ± 0.03 |
| Reciprocating | Disk | Hot Pressed Ni-WB4 (1450 C.) | 4.32 ± 0.03 |
| wear | 2.1″ OD × 0.25″ | DCS Ni-WB4 (1800 C.) | 5.65 ± 0.02 |
| | | Co cemented WC (control) | 14.50 |
| Die insert | Hollow cylinder | Hot Pressed Ni-WB4 (1450 C.) | 4.47 ± 0.02 |
| | 20 mm OD, 8.15 mm ID | | |
| | 53 mm L | | |

Table 2 provides measurements of bulk density for some of the materials described herein.

TABLE 3

| | Average coefficient of | | Wear Rate × 10⁻⁵ | |
|---|---|---|---|---|
| Sample | friction (COF) | | (mm3/Nm) | |
| Ni-WB₄, Hot pressed 1450 C. | 0.14, 0.13 | (top side) | 5.43, 4.98 | (top side) |
| (4.32 g/cm³) | 0.48, 0.19 | (bottom side) | 33.5, 42.5 | (bottom side) |
| N1-WB₄, SPS 1800 C. | 0.61, 0.62 | (top side) | 13.3, 3.40 | (top side) |
| (5.68 g/cm³) | 0.67, 0.58 | (bottom side)* | 28.3, 10.9 | (bottom side)* |
| Cobalt-cemented WC, 10% Co | 0.29, 0.31 | (top side) | 1.05, 1.08 | (top side) |
| (14.5 g/cm³) | 0.30, 0.35 | (bottom side) | 1.05, 1.62 | (bottom side) |

Table 3 provides measurements of average coefficient of friction and wear rate for some of the materials described herein.

Alternate Methods of Production of Tungsten Tetraboride

In some of the more economical embodiments, tungsten tetraboride is produced from the starting materials of boric acid, carbon, and tungsten oxides. Embodiments that are relatively easy to control include synthesis from tungsten metal and boron metal. Different tungsten particle sizes can be used to generate different primary particle sizes in the tungsten tetraboride that is produced. In some embodiments the reactants are homogeneously mixed by ball milling in a solvent (such as aqueous or solvent based liquids). In other embodiments the reactant mixture is dried and loaded into hexagonal boron nitride crucibles with lids. The crucibles are heated in an argon atmosphere to a temperature of between about 1600 C and 2000 C for a time of between about two hours and twelve hours to form tungsten tetraboride. The tungsten tetraboride is purified to remove excess boron (as described elsewhere herein), if such purification is deemed desirable to improve the hardness, mechanical properties, or thermal/electrical properties of the tungsten tetraboride, depending upon the intended application.

In another embodiment the tungsten tetraboride feedstock is milled to a relatively fine particle size of between about 0.5 microns and about five microns without introducing any contaminants. Solvent-based attrition milling can be used in some embodiments to produce the submicron particle sizes, or dry jet milling can be used in other embodiments for the larger particle sizes.

For some embodiments with tooling-specific applications, prior to powder milling, the tungsten tetraboride powder can be blended with a wax binder, additives, and a metal binder powder (such as nickel, chrome, iron, copper, cobalt, or mixtures of these elements), and then co-milled in an attrition mill to intimately homogenize the metal binder and tungsten tetraboride powder. Amounts of wax binder in various embodiments range from about 0.5 weight percent to about fifteen weight percent. Metal binder amounts in various embodiments range from about five weight percent to about fifteen weight percent.

For some embodiments it is preferential to not perform milling of the synthesized tungsten tetraboride powder due to the metastability of the tungsten tetraboride phase upon subsequent consolidation and sintering. In these embodiments, the synthesized tungsten tetraboride powder is combined with the metal binder and only blended by dispersion in a solvent using ultrasonic energy.

Forming and Consolidation of Tungsten Tetraboride

In various embodiments, a fine-milled powder mixture of tungsten tetraboride, wax, and one or more metal binder is placed into a mold for forming into a desired shape. In some embodiments, smaller forms can be pressed in a metal die to form complex shapes at high rates of production. Larger forms can be isostatically pressed into billets of simple geometries.

After the powder mixture has been consolidated in this manner, shapes with more complex structures can be machined while the pressed mixture is in this green state, using any one or more of a selection of various processes such as milling, turning, grinding, and so forth.

Various shapes are then sintered to temperatures up to about 1700 C, depending on the metal binder composition. In some embodiments, special precautions and temperature profiles are required to remove the wax and organic compounds at lower temperatures without carbon formation or oxidation of the tungsten tetraboride or other components, prior to ramping to the ultimate sintering temperature. Hot isostatic pressing also can be used in various embodiments to sinter the part shapes to a higher density, so as to achieve the desired properties.

In various embodiments, the sintered parts are then precision-machined and polished to the final product through methods such as electrical discharge machining, grinding, milling, polishing, and so forth.

Removal of Excess Boron

Some embodiments of the present disclosure benefit by removing excess boron from the fired tungsten tetraboride powders that are formed as described herein. Various embodiments for removing the excess boron are described below.

Direct leaching of the boron can be performed by a variety of different methods. For example, air oxidation of the boron, which is then followed by leaching or heat treatment. Pure boron is directly leached in one embodiment by using a liquid that selectively erodes or dissolves boron. This uses a liquid that dissolves boron but not tungsten tetraboride. Examples of such liquids include boiling nitric and sulfuric acid.

Boron also dissolves in molten copper, iron, magnesium, aluminum, calcium, Na₂O₂, and Na₂CO₃/KNO₃. This can be accomplished by, for example, mixing tungsten tetraboride with the hot acid mix, filtering or centrifuging to separate insoluble portions, mixing tungsten tetraboride with copper, aluminum, or magnesium, then heating the mixture to above the melting points of the metals while wicking away the molten metal/boron mixture.

Another embodiment employs liquid phase oxidation that is followed by leaching or heat treatment. The boron is selectively oxidized in air or oxygen, then heated to vaporize B₂O₃, or dissolved in water or some other solvent. Pure boron is reported to oxidize at a temperature of between about 600 C and 700 C in air. B₂O₃ has a significant vapor pressure above 1600 C

In other embodiments, boron is physically separated according to the differences in density between the excess boron and the other materials in the mix. This can be accomplished in various embodiments by selectively oxidizing or reacting the boron with a material that is soluble in a common solvent with a liquid solution. In various embodiments, one or more of water, peroxide, and methanol can be used.

Various embodiments of physically separating the excess boron include cyclone/hydrocylone, fluidized bed, centrifugation, vibrating table, froth flotation, magnetic density separation.

In another embodiment the excess boron in the fired tungsten tetraboride powder is converted to a different compound that exhibits material properties that are more compatible with the usage goals of the tungsten tetraboride than pure boron, such as B₄C. Boron is converted to B₄C in one embodiment by adding pure carbon and heating the mixture to above a temperature of about 1200 C.

In one test of this embodiment, tungsten tetraboride was mixed with a stoichiometric amount of carbon to form B₄C from the excess boron, and heated to a temperature of between about 1200 C and 1600 C in argon.

In another embodiment, transition metal borides can be formed, which have a higher electrical and thermal conductivity as compared to B₄C. By either pre-converting boron to B₄C, or using different mixtures of transition metals/oxides and pure carbon (or magnesium), ZrC, CO, or nothing can be selectively generated as a by-product.

In another embodiment, a material can be included in the reaction mixture that converts the excess boron to another compound that either has desirable material properties or is easily removed at a later time. For example, adding excess carbon in the WOₓ/boric acid method described elsewhere leads to the formation of B₄C (and WB₂) during the synthesis process.

In another embodiment, the metal binder can react with the excess boron to form a cementing metal boride phase which offers at least one of hardness and corrosive protection advantages. In one test of this embodiment, nickel metal powder was utilized to create a WB₄-NiB cemented material, and verified by XRD to contain only the WB₄ phase and the NiB phase.

Further embodiments include a magnesiothermal reduction, addition of transition metals or oxides to make borides, and adding a material that makes a soluble or high vapor pressure boron compound.

### SUMMARY

To summarize some of the embodiments:

There is a strong correlation between hardness versus density for coupons cemented with copper, iron, and nickel.

Tungsten tetraboride consolidated using SPS at 1620° C. has a hardness of 25 GPa at 100 N, which is roughly 60% higher than cobalt-cemented tungsten carbide. The density of this material is ˜5.59 g/cm3, compared to ˜14.3 g/cm3 for cobalt -cemented tungsten carbide.

Replacement of cobalt-cemented tungsten carbide with this material would eliminate cobalt, and reduce tungsten by roughly 68%. In other words, a billet of nickel-tungsten tetraboride the same dimensions of a billet of cobalt-tungsten carbide would contain 68% less tungsten.

The overall wear rate of nickel-tungsten tetraboride specimens in ASTM G133 testing is higher than cobalt-cemented tungsten carbide, and highly variable. The rate of material removal by diamond pad grinding was reduced significantly when increasing consolidation temperature from 1450° C. to 1620° C.

The compressive strength of nickel-tungsten tetraboride improves by ˜5.6X when increasing the consolidation temperature from 1450° C. to 1620° C.

Testing of a nickel-tungsten tetraboride die insert showed that it behaved similarly to a B₄C insert and was able to press several thousand cycles of B₄C pellets at 12-ton pressure.

Consolidating nickel-tungsten tetraboride to a high density (5.59 g/cm³ or above) tends to enhance mechanical performance.

Nickel-tungsten tetraboride consolidated to a density of ˜5.59 g/cm³ or above is a promising potential replacement material for cobalt-cemented tungsten carbide. The hardness of the material is superior to commercial cobalt-cemented tungsten carbide.

In terms of forming parts, increasing the consolidation temperature of nickel-tungsten tetraboride from 1560 to 1620° C. in SPS greatly improved the density and hardness. Improved performance at high consolidation temperature also suggests using a binder metal with an even higher melting point than nickel. For example, using chromium as a cementing metal (melting point of 1907° C.) would allow consolidation at 2000° C. This would combine the advantage of consolidating pure tungsten tetraboride at 2000° C., which gave the highest hardness of any material in this study, with a temperature well above the melting point of the binder metal, which was also found to be advantageous with nickel-tungsten tetraboride.

APPLICATIONS

There are many product areas for nickel-cemented tungsten tetraboride that could benefit from the various embodiments described herein, including the manufacturing and machine tooling industry. Further segmenting the addressable industry segments into typical products targeted by nickel-tungsten tetraboride include:

Automotive components such as ball joints, brakes, and crank shafts

Mining and infrastructure components such as downhole drilling/cutting teeth and asphalt road planning bits

Powder metallurgy tooling such as press dies/punches, bushings, and wear parts for coining/sizing operations

Metalworking tools such as inserts, drill blanks, and rods

Canning tools for deep drawing of two-piece cans

Rotary cutters for high-speed cutting of artificial fibers

Metal forming rolls and tools for wire drawing and stamping applications

Rings and bushings typically for bump and seal applications

Woodworking, e.g., for sawing and planing applications

Pump pistons for high-performance pumps (e.g., in nuclear installations)

Nozzles, e.g., high-performance nozzles for oil drilling applications

Dental grinding and milling bits

Recycling machinery components such as shredding cutters and crushers

Roof and tail tools and components for high wear resistance

Balls for ball bearings and ballpoint pens

Jewelry

Powder metal industry compaction tooling, such as is used in hydraulic and electric uniaxial pressing of metal and ceramic powders

Metal pressing and forming applications such as aluminum can pressing, coining presses, and so forth

Wear surfaces in industrial processes such as liners, tables, wire/thread guides, and so forth

The foregoing description of embodiments for this invention has been presented for purposes of illustration and description. It is not intended to be exhaustive or to limit the invention to the precise form disclosed. Obvious modifications or variations are possible in light of the above teachings. The embodiments are chosen and described in an effort to provide illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. A method of forming cemented tungsten tetraboride, the method comprising the steps of:
combining tungsten and boron in a molar ratio of from about 1:6 to about 1:12, respectively,
firing the combined tungsten and boron in a hexagonal boron nitride crucible at a temperature of from about 1600 C to about 2000 C, to form tungsten tetraboride,
selectively milling the tungsten tetraboride to a powder,
adding a metal binder to the tungsten tetraboride powder to produce a metal-tungsten tetraboride mixture,
compressing the metal-tungsten tetraboride mixture, and
sintering the compressed metal-tungsten tetraboride mixture to form cemented tungsten tetraboride.

2. The method of claim 1, wherein the metal binder is at least one of copper, iron, and nickel.

3. The method of claim 1, wherein the temperature is about 1800 C.

4. The method of claim 1, wherein the firing is accomplished at about one atmosphere.

5. The method of claim 1, wherein the firing is accomplished in an argon environment.

6. The method of claim 1, wherein the tungsten is provided as tungsten oxide.

7. The method of claim 1, wherein the boron is provided as boric acid.

8. The method of claim 1, wherein the tungsten is provided as tungsten metal.

9. The method of claim 1, wherein the boron is provided as boron metal.

10. The method of claim 1, wherein the tungsten and the boron are combined with carbon in the crucible.

11. The method of claim 1, wherein the sintering comprises at least one of spark plasma sintering, hot pressing, and vacuum sintering.

12. The method of claim 1, wherein the firing is accomplished in one of an argon environment or a vacuum environment, and the sintering is accomplished using spark plasma sintering in one of an argon environment or a vacuum environment.

13. The method of claim 1, wherein the metal binder is added to the tungsten tetraboride powder and blended and dispersed using ultrasonic energy without any mechanical milling.
